(19) United States
(12) Patent Application Publication
(10) Pub. No.: US 2002/0111154 A1
(43) Pub. Date: Aug. 15, 2002

(54) Location based delivery

(76) Inventors: Charles A. Eldering, Doylestown, PA (US); Frederik M. DeWolf, Ithaca, NY (US); Douglas J. Ryder, Doylestown, PA (US)

Correspondence Address: Douglas J. Ryder, Technology, Patents and Licensing, Inc., 340 North Broad Street, Doylestown, PA, 18901, US

(21) Appl. No.: 09/782,960

(22) Filed: Feb. 14, 2001

(51) Int. Cl. H04M 3/42

(52) U.S. Cl. 455/414; 455/456

(57) ABSTRACT

Matching data (advertisements, services, and information) to a subscriber based on a location of the subscriber and a profile of the subscriber. A wireless device that the subscriber is traveling with is used to determine the location of the subscriber. The data may be delivered to the subscriber via the wireless device, via other media, or a combination thereof. The data may also be matched and delivered to the subscriber based on predicted data (activity, route, or location) of the subscriber. The predicted data is generated by monitoring past actions of the subscriber.

### BACKGROUND OF THE INVENTION

The advent of wireless communications provides the ability for users to communicate from a moving location. Wireless communications requires a wireless device and a wireless network. Analog wireless devices provide the ability to transmit voice over the wireless network. Digital wireless devices provide the ability to transmit voice and data over the wireless network. In fact, the new digital wireless devices provide access to the Internet.

The use of wireless communications enables individuals to make transactions (either verbal or electronic, such as via the Internet) from a mobile location. Many transactions performed from a mobile location are independent of location. For example, you can talk to a friend or business associate, you can order a computer for your office, or you can search the Internet for office furniture. Any of these activities can be performed whether you are in Philadelphia or Los Angeles or whether you are at your desk, in a car or on a train. These types of transactions are often referred to as mobile commerce (M-commerce).

However, many mobile transactions require the location of the user be known. For example, calling for a tow truck to assist your stranded vehicle requires that you know your location in order for the transaction to be consummated. Furthermore, some transactions require the location be known so that the transaction can be routed to the appropriate party. For example, services such as the Emergency 911 System, require that the location be known so that the Emergency call can be routed to the appropriate call center.

Traditional fixed position telephones are assigned to a specific emergency call center. Moreover, the location of the call can readily be identified by the caller identification (CID) that is mapped to a specific physical location in the call center's database. Thus, an appropriate emergency services response can be made without further communication from the caller.

Wireless phones have no fixed position, therefore without communication from the caller to identify their present location an appropriate dispatch (emergency response team to the correct location) cannot be made. Moreover, the wireless phone is assigned to a home location so that a ‘911’ call is normally routed to the 911 emergency center associated with the home location, which could be on the other side of the country. Due to the above noted concerns with wireless phones adequately handling ‘911’ calls, the government has implemented regulations on it's 1996 Telecommunications Act that require cellular service providers be able to determine the location of a ‘911’ call within 1/10 mile or 121 meters by Oct. 1, 2001.

The industry is working on various alternatives to meet the government regulation requiring the service provider be able to determine a cellular phone's location One alternative entails determining the location of the wireless device within the cellular phone network by calculating the differences in arrival time of the device's signal at one or more antennas in the system. U.S. Pat. No. 5,890,068 assigned to Cell-loc discloses one method and U.S. Pat. No. 5,999,124 assigned to Snap-Track discloses an alternative method.

An alternative technology that is being developed places global positioning satellite (GPS) functionality on a chip that is placed in the wireless device. The GPS chipset would provide the location of the cellular phone in coordinates that can be turned into a location. The GPS data could be combined with the caller ID data and forwarded to the call center as the emergency call was placed. Motorola disclosed such a GPS chipset in their product literature, “Motorola Announces Oncore™ Remote GPS Precision Timing Receiver”, printed from the World Wide Web site http://www.motorola.com/ies/GPS/pressrls/050498.html on May 5, 2000.

The use of GPS systems (GPSS) to determine an individual's location is becoming wide spread. For example, handheld devices have been developed that include a GPS receiver to determine an individual's location and map data so that the position of the individual can be displayed on a map. U.S. Pat. No. 5,528,248 assigned to Trimble Navigation discloses a personal location assistant (PLA), comprised of technology sufficient to determine present position as well as a compass that provides for taking readings of present and prior headings. The PLA is capable of receiving a downloadable map and retaining the map in computer memory. The PLA is then capable of providing directional readings, determining the devices position in terms of longitude and latitude, and overlaying the co-ordinations on a displayed digital map. The current heading can also then be displayed as an overlay allowing for highly accurate real time navigation.

The GPS functionality can be also be found in Handspring's Visor personal digital assistant (PDA) when used in combination with a Geode add-on module manufactured by GeoDiscovery. The Geode™ GPS Module is a global positioning system that slides into the Springboard slot of any Handspring Visor PDA. It works with GeoView™ Mobile Palm-based software that provides for the ability to place any position or location on an interactive map. The Geode™ includes a digital compass that senses the direction the unit is headed and orients the map accordingly. This is as disclosed on the GeoDiscovery website, http://www.geodiscovery.com/geodepp.html, printed May 17, 2000.

Another example of the expanding use of this technology is the deployment of vehicle navigation systems developed for the consumer market. These systems are generally found to be of two types. The first type is comprised of a GPS unit, a compass, a map database, and a user interface (visual and/or with a voice interface). The core functionality of the system (location determination, and relative position on a map) is enhanced by using input from the vehicle to provide other relevant data that can be used in aiding navigation. This input can be the speed of travel, and help in determining if turns (changes in direction) have been taken. This type of device is disclosed, U.S. Pat. No. 5,862,511 assigned to Magellan.

The second type of navigation system relies on the combination of a GPS unit, a cellular telephone and a call center. The position of the vehicle is determined by making use of the GPS unit. When a user initiates a session with the call center, the GPS unit relays the coordinates to the call center via a dedicated cellular telephone. The call center is staffed by an operator. The operator is able to view a map with the position of the vehicle displayed on it. The occupant of the vehicle is then able to converse with the call center operator who serves as the navigator, giving instructions and guidance to the occupant of the vehicle. The product literature from Onstar, “OnStar Services,” printed from the World Wide Web site http://www.onstar.com/service/services.htm on Jul. 7, 2000 discloses this type of service. This service is currently being offered as a dedicated service in vehicles that limits its portability and adaptability for use away from the vehicle.

This technology's primary benefit has been in providing emergency responses to mayday calls from the vehicle. With the GPS unit providing the current location, no other information is needed to coordinate an emergency response. This has been referred to as Automatic Vehicle Location (AVL). See Trimble Navigation, Ltd., U.S. Pat. No. USRE035920. Manufacturers of the vehicles have the ability to enhance this functionality by connecting this communication channel to the crash protection systems, typically airbag circuits, so that in the case of accident, an automatic crash notification (ACN) signal can be sent to the call center.

It has been through a separate set of developments that an advertising supported business model can be now applied to wireless communications. An article from the Wall Street Journal Interactive Edition, “Dial the Web: MobileID Invests in Cell-Phone Search Engine”, printed from the World Wide Web site http://interactive.wsj.com/archive/retrieve.cgi?id=SB964645721139 838971.djm&template-doclink.tmpl on Jul. 7, 2000, discloses just such a business model. The annoyance of having communications interrupted or delayed by advertisements and promotions may limit the acceptance of these services.

In other recent developments, the capabilities of PDA's have been expanded to provide wireless access to data, notably Palm Computings, Palm VII device and the wireless data service provided by the same company. In product literature from Palm, Inc. “Palm's Web Clipping Network”, obtained from the World Wide Web site http://www.palm.com/pr/palmvii/7whitepaper.pdf published on Jan. 1, 1998 discloses a PDA with wireless data access. This device makes use of a proprietary set of network servers to ‘clip’ data from Web Sites and to prepare the information in an appropriate format for devices using the Palm Operating System, or the Palm OS. Currently, these networks do not make use of automatically determining the subscriber's current location in order to deliver appropriate services.

Computer protocols have been developed that allow for the transfer of Internet content to cellular telephones. The telephones have evolved to provide for a larger display of information. As a subset of WWW protocols, Wireless Application Protocol (WAP) enables the conversion of Hyper Text Markup Language (HTML) or Extensible Markup Language (XML) formatted information into a thinner more streamlined set of data. WWW Server sites are preparing their information to be more suitable for transfer to WAP devices. These services are available to the public at the present on a limited basis.

Initial strides have been made in combining the delivery of marketing materials to these devices. The product literature from GeePS, “GeePS”, printed from the World Wide Web site http://www.geeps.com/technol.htm on May 27, 2000 discloses just the same service. A variation on this service is disclosed in product literature from Vicinity, “The Vicinity Business Finder”, printed from the World Wide Web site http://www.vicinity.com/vicinity/datasheets/finder.pdf on Jul. 24, 2000. These services are not ubiquitous and at the present have limited appeal either to consumers or retailers.

Pure proximity based services are not necessarily of significant value. It may be that while I am in close proximity to a McDonalds restaurant, and that McDonalds is currently running a marketing campaign that includes a coupon entitling me to a discount, and that I am equipped with a device capable of determining my location and that my service provider has agreed to deliver the marketing materials to its subscribers, I may never have eaten at a McDonalds nor might ever intend to. Sending me the advertisement would be both a waste of McDonalds time as well as mine. The service provider might irritate me with irrelevant materials to the point where I unsubscribe from their service.

Thus, there is a need for a system and method for delivering advertisements to subscribers not only based on their location but also based on a profile of a subscriber, so that the advertisements delivered to the subscriber can be targeted based both on location and some characteristic(s) of the subscriber.

### SUMMARY OF THE INVENTION

The present invention discloses a new and innovative method for delivering advertising that makes use of current or predicted activity. The ability to anticipate or predict activity employs profiling that makes use of location and activity information.

According to one embodiment, the method of developing location-based profiles relies on patterns of observed activities, to create a system of categorizing these patterns into types and to use those types to both anticipate and to identify an activities. These patterns of activity can be described as paths.

It is observed that life, and the activities that we conduct have certain patterns to them. In the course of conducting our lives, we repeat with some amount of regularity certain activities. These activities include commuting to work, running errands on the weekend, or going out to eat every so often. While the actual locations that we travel to and from might change over time, say when we move to a new city, except a new job, or when one of our children changes schools, it is possible to observe the same types of activities. That is to say, we might take a new job, but we would still exhibit a type of activity, that is commuting, albeit to a different location.

It is also observed that once patterns of behavior have been established that the routes one takes during the course of those activities become established and routine. It is observed that these are predictable and do not vary greatly. For example, once a pattern for commuting is established, the route on takes during the course of that activity does not vary greatly. These patterns of particular types of activities occur along consistent routes and may be said to become paths. This implies that from an individual's perspective, they become well worn and familiar.

It is argued that during the course of, or just prior to conducting, certain activities, an individual would be more receptive to an advertisement or other marketing information, as opposed to receiving the same advertisement during the course of another activity. For example, during the course of commuting home from work, one might integrate several errands into the course of the trip. The relevancy of being presented an advertisement for a dry cleaning service on the way to work would be less than just prior to or during the commute on the way home from work. This speaks to the need to develop profiling methods that incorporate both the types of activity in conjunction with predictable paths. The advertising system disclosed herein makes use of these profiles to deliver highly targeted appropriate and effective advertising based on these profiles.

These and other features and objects of the invention will be more fully understood from the following detailed description of the preferred embodiments that should be read in light of the accompanying drawings.

### BRIEF DESCRIPTION OF THE DRAWINGS

The accompanying drawings, which are incorporated in and form a part of the specification, illustrate the embodiments of the present invention and, together with the description serve to explain the principles of the invention.

In the drawings:

FIG. 1 illustrates a generic wireless/satellite network that can be used to locate a mobile device;

FIG. 2 illustrates an exemplary use case diagram, according to one embodiment of the present invention;

FIG. 3 illustrates an exemplary communication platform for matching data to the subscriber and delivering the data to the subscriber, according to one embodiment of the present invention; and

FIG. 4 illustrates an exemplary activity diagram, according to one embodiment of the present invention.

### DETAILED DESCRIPTION OF THE PREFERRED EMBODIMENT

In describing a preferred embodiment of the invention illustrated in the drawings, specific terminology will be used for the sake of clarity. However, the invention is not intended to be limited to the specific terms so selected, and it is to be understood that each specific term includes all technical equivalents which operate in a similar manner to accomplish a similar purpose.

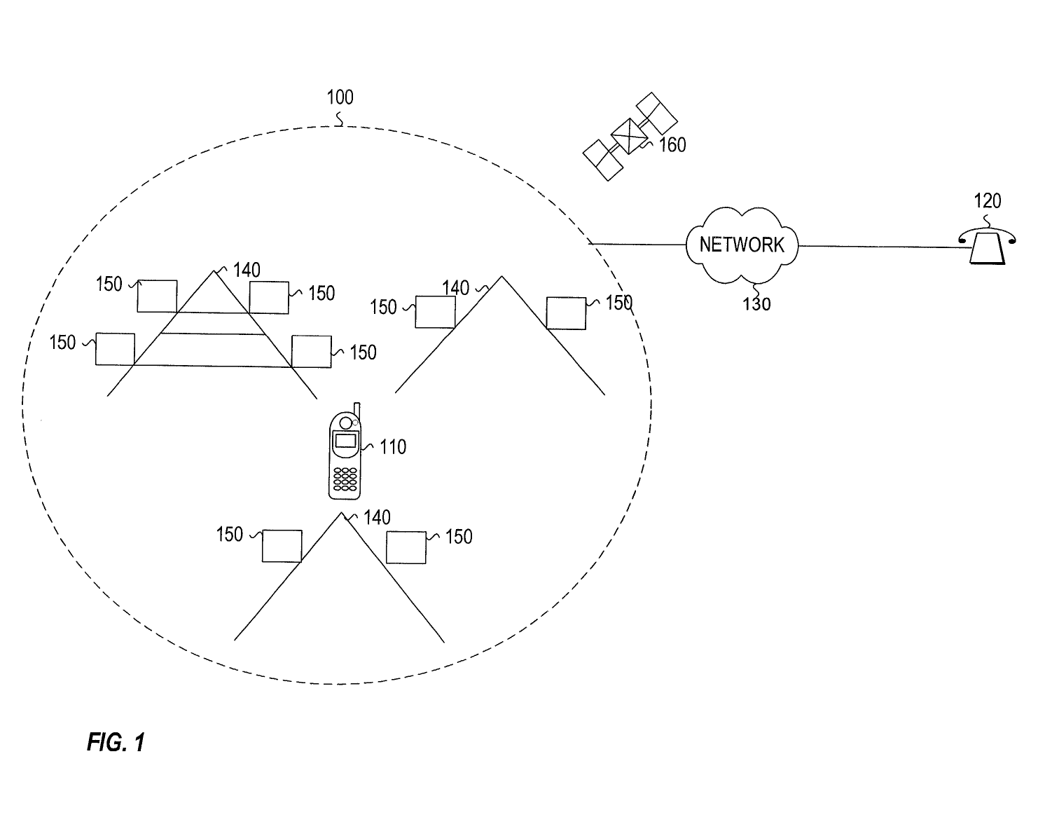

With reference to the drawings, in general, and FIGS. 1 through 4 in particular, the apparatus of the present invention is disclosed.

FIG. 1 illustrates a simplistic wireless network 100 connecting a wireless device 110 to a final destination 120 via a network 130. As illustrated the wireless device 110 is a wireless phone. However, as would be obvious to one of ordinary skill in the art, the wireless device 110 could be a personal digital assistant (PDA), such as a PALM Pilot or Handspring Visor, an internet enabled vehicle, a portable computer having a wireless Internet connection, a combination wireless phone/PDA or any other device now known or later conceived that provides wireless communications. As illustrated the final destination 120 is a stationary phone, but could be a wireless phone, a beeper, a service provider, the Internet, a private network, a computer, or numerous other devices without departing from the scope of the current invention.

As illustrated, the wireless network 100 consists of three towers 140. As one of ordinary skill in the art would recognize, the wireless network 100 would consist of a plurality of towers, with the number depending on the size of the network. As illustrated each of the towers 140 include multiple receivers 150. In practice, different wireless service providers operating out of that location probably have their own receiver 150 on the tower 140. The service provider may only handle calls for their customers or it may also contract with other wireless providers to provide service for their customers. For example, if Verizon did not provide wireless service in California, they may contract with Pacific Bell for Pacific Bell to handle the wireless communications for them in California.

Wireless communications can be analog or digital. Moreover, there are numerous standards used for processing wireless digital communications, including but not limited to, code division multiple access (CDMA), global standard for mobile (GSM), personal communications system (PCS), universal mobile telecommunications systems (UMTS), and other 3^{rd} generation (3G) wireless systems. Wireless devices 110 and the wireless service providers are developed to work with one of these standards. For example, Sprint phones and their wireless network are both based on the PCS standard. The PCS network cannot process communications from non-PCS wireless devices and the PCS wireless devices cannot communicate over non-PCS wireless networks. As one or ordinary skill in the art would recognize, most digital wireless devices can communicate in analog if digital service is not available. Moreover, it is within the scope of the current invention to have wireless devices and/or wireless networks that can communicate according to various standards.

Each of the towers 140 connects to the network 130. The network 130 may be a telecommunications (telecom) network, such as a public switched telephone network (PSTN), a hybrid fiber coaxial (HFC) network, a fiber to the curb (FTTC) network, a fiber to the home (FTTH) network, a digital subscriber line (DSL) network, other landline networks now known or later conceived, a satellite system, a wireless system, other systems now know or later discovered or a hybrid of these systems, without departing from the scope of the current invention. FIG. 1 also illustrates a GPS satellite 160 for providing latitude and longitude coordinates. As would be obvious to one of ordinary skill in the art, multiple GPS satellites would be required, however only one is illustrated for simplicity.

When the wireless device 110 initiates communications, a signal is sent from the wireless device 110 and is received by the receivers 150. The appropriate receiver 150 forwards the signal based on who the service provider is, whether they actually provide service in that location or are contracting with a local provider, and the destination of the communication. The location of the subscriber can be identified by the wireless system. For example, determining the difference in time that the signal is received at three towers or the difference in the angle that the signal is received at two towers can identify the location. Alternatively, a GPS chipset that is located within the device can determine the location of the subscriber.

As previously discussed, the location of the subscriber is important in order to route a ‘911’ call to the appropriate response center. In addition, the location of the subscriber can be utilized to assist in the delivery of advertising, information and services. For example, if the subscriber is near a Pizza Hut they may be delivered an advertisement from Pizza Hut. If an individual calls for a Pizza from a location without a defined address, such as a park, the pizza can be delivered to that location based on the location data (i.e., latitude and longitude coordinates identified as a point on a map). The location data would be provided the service provider directly or would be provided to a third party who will forward the location data to the service provider. If a subscriber is in an unfamiliar location and wants information about local attractions, the subscriber's location will be known so that information about that location can be delivered to the subscriber.

However, delivering a subscriber advertisements, services or information based simply on location is not practical. For example, if a subscriber does not like coffee there would be no benefit to send the subscriber an advertisement for Starbucks just because they are in close proximity to one. Likewise, if a subscriber never frequented bars, there would be no reason to send them a listing of the hottest nightclubs in the location they were at.

Thus in a preferred embodiment, characteristics about the subscriber (i.e., a subscriber profile) will be known so that the delivery of advertisements, services and information can be tailored (targeted) to that subscriber. For example, if you know that the subscriber likes nice cars you may send him an advertisement for the local BMW dealers in the local area. The characteristics about the subscriber may include demographics, psychographics, product preferences, service preferences, hobbies, likes, dislikes, other categories, or combinations thereof. The characteristics may be provided by the subscriber, may be generated based on actions of the subscriber, or some combination thereof. The subscriber may provide the information by filling out a survey or may simply provide any information they decide is relevant and worth sharing. The actions that may be used to characterize the subscriber include but are not limited to purchases (products and/or services), channel changes, Internet browsing, locations visited, routes, other transactions, and combinations thereof.

According to a preferred embodiment, a predicted activity and/or route of the subscriber can be used to deliver advertisements, services and/or information to the subscriber in advance of their actual arrival at the location. For example, if it is known that the subscriber will be commuting to work on Monday morning via I95, data (advertisements, services, or information) related to locations on that route may be transmitted to the subscriber in advance. In a preferred embodiment, the predicted activity/route data is used in conjunction with the subscriber profile so that targeted data can be delivered to the subscriber.

According to one embodiment, a single entity will gather data about the subscriber and develop a subscriber profile. The gathered data may include multiple types of transactions (i.e., purchases, channel changes, Internet browsing) or may be based on just one type of transaction (locations visited). In another embodiment, separate entities would gather data about different transactions and these transactions or some subset thereof would be combined to create the subscriber profile.

Applicant's co-pending U.S. Application No. XX/XXX,XXX (attorney docket no. L100-10) entitled “Location Based Profiling” filed concurrently with the present application describes a method for profiling a subscriber, and for predicting a route of the subscriber based on tracking where the subscriber roams (locations and times). Application XX/XXX,XXX (attorney docket no. L100-10) is herein incorporated in its entirety by reference, but is not admitted to be prior art.

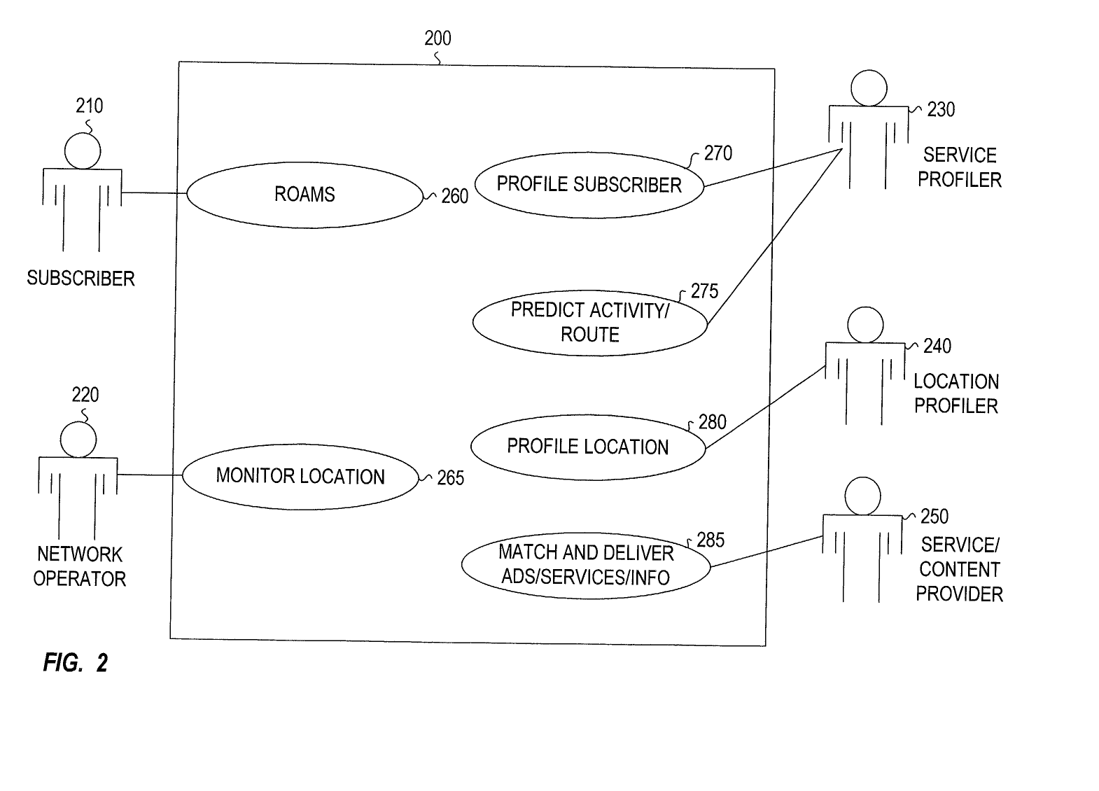

FIG. 2 illustrates an exemplary use case diagram having different actors and a set of use cases, which represent the action performed by those actors, for carrying out one embodiment of the present invention. As illustrated in the use case diagram 200, the set of actors involved in the present system includes a subscriber 210, a network operator 220, a subscriber profiler 230, a location profiler 240 and a service/content provider 250. The subscriber 210 has a wireless device that is capable of determining the location of the subscriber 210 as the subscriber roams (260) with the device. Though not illustrated in the use case diagram 200, the subscriber 210 is likely receiving some form of wireless service from a wireless network provider. As would be obvious to one of ordinary skill in the art, the wireless service can include telephone service, Internet access, private network access, paging service, data service, or any other wireless service now known or later conceived. The subscriber 210 may subscribe one or multiple devices, the devices including but not being limited to wireless phones, PDAs, wireless portable computers, and Internet enabled vehicles.

The network operator 220 monitors the location of the subscriber 210 (265). As previously discussed, the location of the subscriber 210 can be determined by the wireless network 100 or can be determined using the GPS system 160. The location profiler 240 generates a profile of the location based on attributes (i.e., housing prices, type of community) associated with the location, and establishments (i.e., businesses, retail establishments) located within the location (280). The data regarding the attributes of a location may be gathered using map databases, census data, local government data, business records, or other databases or entities that would have this type of data. The location profiler 240 may gather the data about attributes and establishments or this data may be provided to the location profiler 240 by a third party.

The subscriber profiler 230 receives data about where the subscriber is roaming (i.e., from the network operator 220) and retrieves location profile data from the location profiler 240 in order to generate a profile of the subscriber (270) and to predict activity and/or routing patterns of the subscriber (275). In order to determine the profile (270) or activity/routing (275) of the subscriber attributes such as time of day, day of week may be collected in order to determine the type of activity (i.e., shopping, commuting).

The service/content provider 250 delivers advertisements (ads), information and/or services to the subscriber 210 based on their actual or predicted location, their subscriber profile, and the location profile (285). That is, the service/content provider 250 matches the data (ads, services, information) to the subscriber 210 by taking into account where the subscriber 210 is (or where the subscriber 210 is predicted to be), what the characteristics (profile) of that location are, and what the characteristics (profile) of the subscriber are. For example, if the subscriber 210 is traveling towards, Doylestown, Pa. (a town having several museums) and the subscriber likes museums, the subscriber may receive an ad on their wireless device for Doylestown (a town having museums), or for one or all of the museums. Likewise, if the subscriber 210 asks for information on their current location, they may be given information regarding the museums since it is known that that is of interest to the subscriber 210.

The actors illustrated in FIG. 2 may each be a separate entity, a single entity may perform the tasks associated with multiple actors, several entities may be required to perform the tasks associated with a single actor, or some combination thereof. For example, a wireless phone provider may be the network operator 220 and the subscriber profiler 230. Alternatively, one entity may match and deliver ads, a separate entity may match and deliver services, and a third entity may match and deliver information (the three in conjunction with each other forming the service/content provider 250). As one of ordinary skill in the art would recognize, there are numerous variations to the exemplary embodiment and separate distinct embodiments that are well within the scope of the current invention.

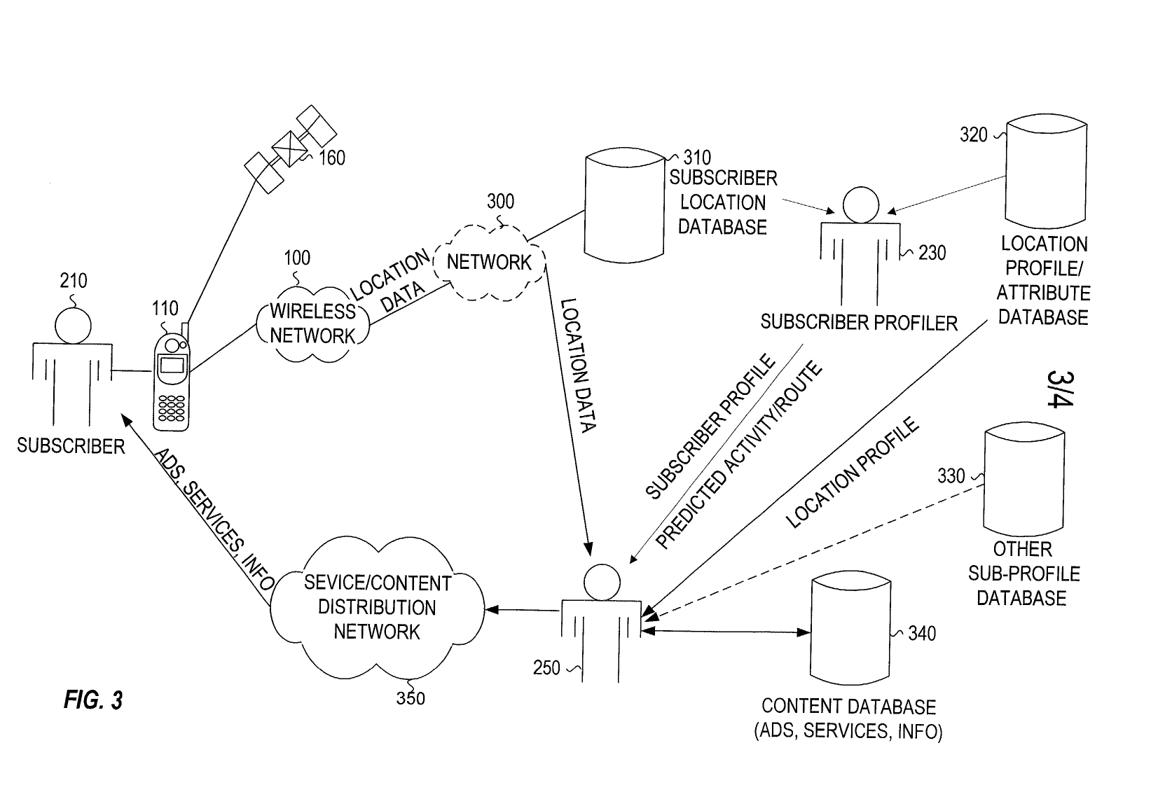

FIG. 3 illustrates a communication platform for supporting the method and system of the present invention. The subscriber 210 is connected to the wireless network 100 via the wireless device 110. As the subscriber 210 roams, his/her location is determined either by the wireless network 100 or by using the GPS network 160. Data related to the subscriber's location (location data) is forwarded to a subscriber location database 310 and the service/content provider 250. The subscriber location database 310 may be part of the wireless network 100 or may be external to the wireless network 100. The location data may be sent to the subscriber location database 310 directly from the wireless network 100 or via a network 300. The network 300 may be a telecom network, a private network, the Internet, or any other network capable of providing communications. The wireless service provider may maintain the subscriber location database 310 or a third party may maintain it. The location data saved may be raw data or may be aggregated data.

According to a preferred embodiment of the current invention, in addition to location data being stored in the subscriber location database 310, the time associated with the location will also be stored. The subscriber profiler 230 extracts data from the subscriber location database 310 and generates predicted activities and/or routes for the subscriber 210. In addition, the subscriber profiler 230 extracts data from a location profile/attribute database 320. The location profile/attribute database 320 consists of data related to locations. For example, the location profile/attribute database 320 may include the type of businesses, stores, points of interests, etc. associated with locations. Moreover, the location profile/attribute database 320 may include data on characteristics associated with the location, intended visitors to the location, establishments within the location, etc. The characteristics may include but are not limited to demographics, store preferences, product preferences, likes and dislikes.

The subscriber profiler 230 may use the data from the location profile/attribute database 320 to identify the type of establishments that the subscriber 210 may pass on the predicted routes. Furthermore, the subscriber profiler 230 may generate a profile of the subscriber based on the data from the two databases 310, 320. The subscriber profile may include a probabilistic determination of the demographic make-up (i.e., race, age, gender, income), and the preferences (i.e., product, store) of the subscriber 210.

As illustrated in FIG. 3, the service/content provider 250 is also receiving the location data from the wireless network 100 directly, or via the network 300. Thus, the service/content provider 250 would have location data on a plurality of subscribers 210 (any subscriber 210 utilizing the wireless service and having their location tracked in some manner). As illustrated, the service/content provider 250 is also receiving the subscriber profiles and predicted routes from the subscriber profiler 230 and the location profile from the location profile/attribute database 320.

In an alternative embodiment, the service/content provider 250 may extract the location data it is interested in from the subscriber location database 310. In an alternative embodiment, a database manager managing the subscriber location database 310 may provide the location data of interest to the service/content provider 250. The location data of interest to a service/content provider 250 may be data associated with subscribers having a particular profile (i.e., like fast food), subscribers frequenting a certain location (i.e., drive within 1 mile of a mall at least once/week), subscribers traveling in the vicinity of a particular location (i.e., within 5 miles of the store), or some combination thereof.

For example, if the service/content provider 250 is an advertiser for a high-end kitchen store they may wish to target ads to subscribers having a specific profile (i.e., upper income) that are either traveling within a 50 mile radius of the store (or are predicted to do so). As would be obvious to one of ordinary skill in the art, the subscribers would have to be associated with some type of identification so that the service/content provider 250 could receive or retrieve data of interest to them from the subscriber location database 310. In a preferred embodiment, the service/content provider 250 would not be given access to the raw subscriber data but would instead be given access to aggregated subscriber data. The aggregated data may be grouped by targeted subscribers or by targeted location.

For example, data related to targeted subscribers may be aggregated in numerous forms including but not limited to a synopsis of the locations visited over a defined period of time, a count of the number of times (or a percentage of time) the subscriber visited a particular location, or a notification when the subscriber is within a certain proximity to a certain location. Data related to targeted locations, may be aggregated in numerous forms including but not limited to a ranking of targeted subscribers that visited the locations most frequently, targeted subscribers that were within a certain radius at least a certain number or times, or an indication of the targeted subscribers that entered within a certain proximity to the location.

According to one embodiment of the current invention, the service/content provider 250 will base the delivery of data to the subscriber 210 on a predicted activity/route. In this embodiment, the subscriber profiler 230 provides the service/content provider 250 with all the data necessary (profile, predicted activity/route) to determine matching ads, services, or information. For example, the service/content provider 250 can match an advertisement to the subscriber 210 based on knowing who the subscriber 210 is or what they like (subscriber profile) and where they will be (predicted activity/route). Thus, there is no reason that the service/content provider 250 needs to retrieve (or receive) data from the subscriber location database 310 or from the wireless network 100 (directly or via the network 300).

As illustrated in FIG. 3, the service/content provider 250 may also receive additional subscriber profile data from other subscriber profile databases 330. As one of ordinary skill in the art would recognize, these additional subscriber profiles could be based on subscriber purchases (product or service), Internet usage, television viewing characteristics, other transactions, or some combination thereof. In an alternative embodiment, the additional subscriber profiles could be provided to the subscriber profiler 230, and the subscriber profiler 230 could use these additional profiles to develop a comprehensive subscriber profile. In another alternative embodiment, the transactions associated with these additional subscriber profiles could be provided to the subscriber profiler 230 and the subscriber profiler 230 could generate a profile based on these transactions and the location data.

The service/content provider 250 also has access to a content database 340. The content database 340 may include data relative to ads, services and information relative to particular locations. While all the data may be indexed according to location, it is not necessarily true that all of the data will be relevant only to that location. For example, an ad for McDonalds is applicable to any area but may only be delivered to a subscriber 210 if they are within a certain proximity to a McDonalds. As illustrated, data related to ads, services and information is contained in one database. However, as one of ordinary skill in the art would recognize, the data may be stored in multiple databases by multiple database managers without departing from the scope of the current invention.

In one embodiment, the network operator 220 can track the subscriber's current location and determine when a service or content delivery opportunity is present and signal that opportunity to the service/content provider 250. According to one embodiment, the opportunity may be determined when the subscriber 210 requests a service through the network operator 220. Alternatively, the opportunity may be determined when the subscriber profile and current (or predicted) location matches, for instance, an ad target profile. The service/content provider 250 may be a service provider such as a pizzeria or an electronic service provider (i.e. local weather, local map, etc.) or a content provider such as an advertiser that delivers ads to the subscriber 210.

For the delivery of advertisements to the subscriber 210, the service/content provider 250 compares the subscriber profile to a target audience for the ad (ad profile). For example, the subscriber 210 may be identified by the subscriber profile as being between the age of 28-35, married with two kids, and having an annual income between $60,000 to $80,000 and the target audience for Babies R' Us, may be the same. According to one embodiment, the ad will only be delivered if the ad profile and the subscriber profile match. According to another embodiment, ads that meet a certain criteria (80% correlation) will be delivered. According to another embodiment, ads will be ranked and delivered based on the rankings. As one of ordinary skill in the art would recognize there are numerous methods for correlating ad profiles and subscriber profiles that would be well within the scope of the current invention.

According to a preferred embodiment, the location (or predicted location) is also used when determining to deliver ads to the subscriber 210. The ads for specific entities (i.e., restaurants, stores, businesses) may identify a distance requirement (i.e., don't deliver any ads unless the subscriber is within 50 miles) or location-rating factor (i.e., 100% if within 2 miles, 80% within 2-5 miles, 60% within 5-10 miles, etc.). If a distance requirement is imposed ads will not be delivered if this requirement is not meet, even if the subscriber profile and the ad profile are a 100% correlation. Alternatively, if the location-rating factor is used, the correlation factor will be updated using the location-rating factor. For example, the correlation factor may be multiplied by the location-rating factor to generate an overall applicability factor. Ads will be delivered to the subscribers based on the applicability factor.

For example, an ad having an 80% correlation with the subscriber but only having a 60% location factor would have an overall applicability factor of 48% (0.80*0.6). An ad having a 70% correlation and a 70% location-rating factor would have an overall applicability factor of 49% (0.7*0.7). Thus, an ad that is not as correlated to the subscriber 210 (70% correlation vs. 80% correlation) would be more applicable to the subscriber 210 based on the subscribers location.

As one of ordinary skill in the art would recognize, there are numerous methods for incorporating location (or predicted location) into the delivery of ads to subscribers that would be well within the scope of the current invention.

As illustrated in FIG. 3, the service/content provider 250 delivers its services and content through a service/content distribution network 350. The service/content distribution network 350 encompasses both electronic communication networks (e.g. telecommunication networks) and networks composed of highways, routes and street that can be used to deliver services (e.g. pizza delivery). The service/content distribution network 350 may also include other distribution networks used to deliver a service, such as the wireless network 100. As illustrated, the two networks (100, 350) are separate but could be the same network without departing from the scope of the current invention.

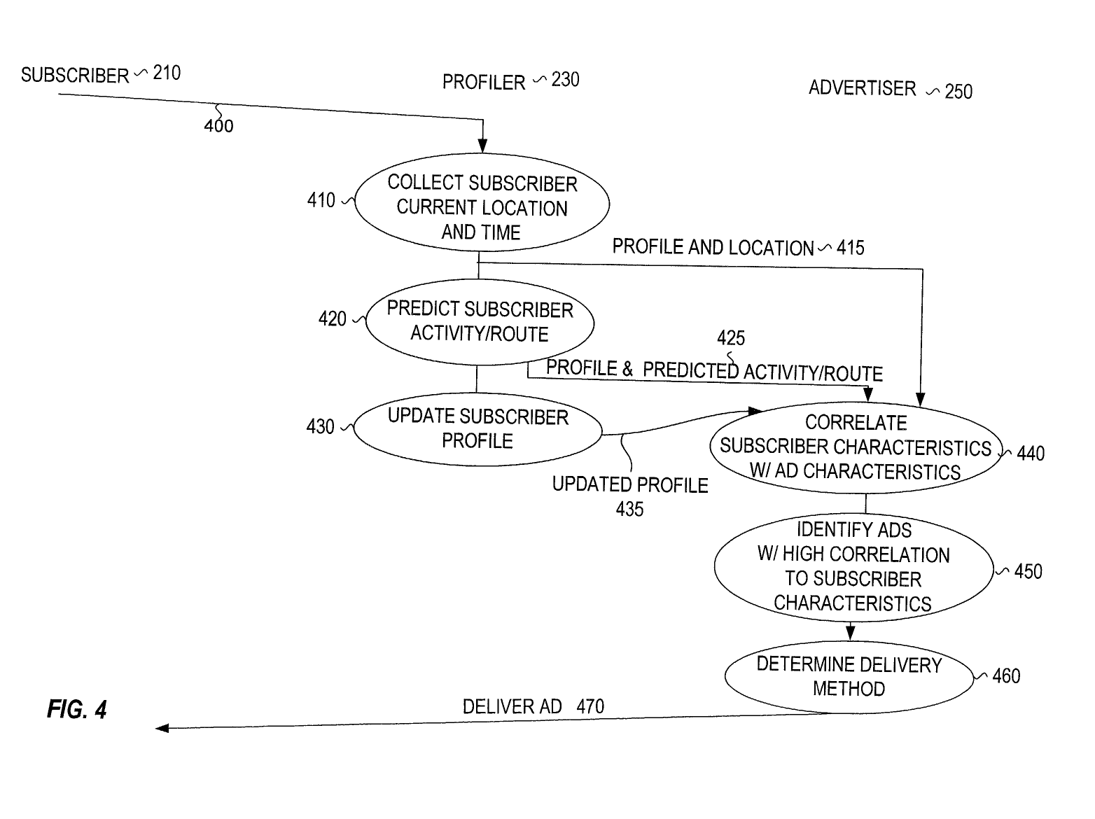

FIG. 4 illustrates an exemplary activity diagram for delivering an ad to a subscriber 210. The three parties illustrated include the subscriber 210, the subscriber profiler 230 and the service/content provider 250 (which in this embodiment is an advertiser). The subscriber 210 is in communication with the subscriber profiler 230 through the wireless network 100 (400). The subscriber profiler 230 receives updates on the subscriber's current location and the time (410). According to one embodiment, the subscriber profile and the current location of the subscriber 210 are transmitted to the advertiser 250. The current time may also be delivered to the advertiser 250 (415), and is preferable for advertisers who base their delivery of ads on time parameters (time of day, day of week, etc.).

According to one embodiment, the subscriber profiler 230 uses the location and time data to predict the subscriber activity and/or the subscriber route (420). The generation of predicted activities/routes is disclosed in Applicant's co-pending U.S. Application No. XX/XXX,XXX (attorney docket no. L100-10) entitled “Location Based Profiling” filed concurrently with the present application, which is herein incorporated by reference in its entirety. For example, the activity may be commuting and the route may be via I95. According to one embodiment, the subscriber profiler 230 transmits the subscriber profile and the predicted activity/route to the advertiser (425). The predicted activity/route may be delivered by itself or with some combination of location, time, and subscriber profile.

According to one embodiment, the subscriber profiler 230 uses the location and time data (as well as attributes associated with the locations) to update the subscriber profile (430). The generation of the subscriber profile is disclosed in Applicant's co-pending U.S. Application No. XX/XXX,XXX (attorney docket no. L100-10) entitled “Location Based Profiling” filed concurrently with the present application, which is herein incorporated by reference in its entirety. For example, the subscriber profile may be updated to reflect a change in lifestyle, such as a new job or new child, or may reflect a change in tastes, such as a new favorite restaurant, or may simply refine the existing subscriber profile. The updated profile may be provided to the advertiser 250 (435). The updated profile may be delivered by itself or with some combination of location, time, and predicted activity/route.

The advertiser 250 correlates the subscriber profile with characteristics reflective of an intended target market for the ad, referred to as an ad profile (440). For example, an ad profile for McDonald's may specify a target profile having the following characteristics: a frequency of eating out in fast food restaurants superior or equal to 30% and a current location being within 2 miles radius from a McDonald restaurant. In this instance, the current location of the subscriber would be considered in measuring the applicability of the ad to the subscriber 210.

Based on the correlation results, the advertiser identifies ads having a high correlation (450). As previously discussed there are numerous methods of identifying the ads that have a high correlation or that meet a threshold correlation that are well within the scope of the current invention. The correlation may be based on mathematical correlation or other metrics calculation techniques known to those skilled in the art and which can measure the degree of closeness of two characteristics.

Once the appropriate ads are identified for delivery, the delivery method is determined (460) and the ad is delivered to the subscriber 210 (470). The delivery methods include but are not limited to via the wireless device, via a video distribution network, such as hybrid fiber-coax (HFC) or switched-digital video (SDV) systems, or via printed media. The type of delivery selected will depend on the subscriber 210 and the effectiveness sought by the advertiser 250.

If the ad is being delivered based on the current location of the subscriber, it is likely that the ad will be delivered via the wireless device. That is, the subscriber will in all likelihood have the wireless device with them and that will be the most likely manner to communicate with the subscriber at that location. The ad can be delivered to the wireless device in numerous manners that include but are not limited to, banner ads, links to Internet web sites or web sites themselves, short text messages, voice messages, streaming media, or any other now known or later conceived method including methods that will be generated with the advent of 3^{rd} generation (3G) wireless devices.

If the ad is based on a predicted path or is based simply on the subscriber profile, then the ad can be delivered to the subscriber 210 using any method or combination of methods now known or later conceived. For example, if the advertiser 250 knows that predicted activity/route for the subscriber 210, that the person commutes to work early in the morning and passes a coffee shop, the advertiser may deliver an advertisement for the coffee shop on the television the night before, may deliver an advertisement for the coffee shop in the morning paper, and then may deliver an ad for the coffee shop on the subscribers wireless device 110 as they begin their commute.

The advertisement delivery method described herein is based on the monitoring of the subscriber activities and location data that, by inference, can depict a “psycho-demographic” profile of the subscriber. The inference may be based on the application of heuristic rules or other known facts to the observed location data and activities to obtain a psycho-demographic profile.

Although this invention has been illustrated by reference to specific embodiments, it will be apparent to those skilled in the art that various changes and modifications may be made which clearly fall within the scope of the invention. The invention is intended to be protected broadly within the spirit and scope of the appended claims.

What is claimed is:

1. An method for delivering targeted advertisements to a subscriber, the method comprising:
receiving a subscriber profile;
receiving a plurality of advertisement profiles;
correlating the subscriber profile to the plurality of advertisement profiles;
selecting the targeted advertisements for the subscriber based on said correlating;
delivering the targeted advertisements to the subscriber.

2. The method of claim 1, further comprising
receiving location data identifying how far the subscriber is from an entity associated with advertisements associated with the advertisement profiles; and
modifying results of said correlating based on how far the subscriber is from an entity;
wherein said selecting is based on said modifying.

3. The method of claim 2, wherein said modifying includes removing from consideration advertisements for entities not within a certain distance from the subscriber.

4. The method of claim 2, wherein said modifying includes applying a proximity factor to results of said correlating.

5. The method of claim 4, wherein the proximity factor is reduced as distance between the subscriber and an entity increases.

6. The method of claim 1, further comprising receiving a location of the subscriber, wherein said receiving a plurality of advertisement profiles includes receiving a plurality of advertisement profiles for entities within a certain distance from the subscriber.

7. The method of claim 6, further comprising receiving a direction of the subscriber, wherein said receiving a plurality of advertisement profiles includes receiving a plurality of advertisement profiles for entities within a certain distance in the direction the subscriber is traveling.

8. The method of claim 1, further comprising receiving a predicted route of the subscriber.

9. The method of claim 8, wherein said receiving a plurality of advertisement profiles includes receiving a plurality of advertisement profiles for entities within a certain distance from the predicted route.

10. The method of claim 8, wherein said receiving a plurality of advertisement profiles includes receiving a plurality of advertisement profiles for entities on and in the direction of the predicted route.

11. The method of claim 6, wherein the subscriber travels with a wireless device and the location of the subscriber is determined using the wireless device.

12. The method of claim 1, wherein the targeted advertisements are delivered to the subscriber on a wireless device.

13. A method for targeting data to a subscriber based on where the subscriber is and some characteristics about the subscriber, the method comprising:
receiving a profile about a subscriber;
receiving a location of the subscriber;
organizing data for the subscriber based on the profile and the location; and
delivering the data to the subscriber.

14. The method of claim 13, wherein the data includes advertisements.

15. The method of claim 13, wherein the data includes services.

16. The method of claim 13, wherein the data includes information.

17. The method of claim 13, wherein the data is delivered when requested by the subscriber.

18. The method of claim 13, wherein the data is delivered to the subscriber when a match between the data and the subscriber is found.
